(19) United States
(12) Patent Application Publication
(10) Pub. No.: US 2005/0259689 A1
(43) Pub. Date: Nov. 24, 2005

(54) Providing soft bandwidth guarantees using elastic TCP-based tunnels

(76) Inventors: Azer Bestavros, Wayland, MA (US); Abraham I. Matta, Wayland, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/096,735

(22) Filed: Apr. 1, 2005

Related U.S. Application Data
(60) Provisional application No. 60/558,736, filed on Apr. 1, 2004.

(51) Int. Cl. H04L 12/26

(52) U.S. Cl. 370/477

(57) ABSTRACT

Method and apparatus for providing enhanced utilization of an existing network of paths between nodes allocated to customer traffic where the paths also carry cross traffic. The system monitors the quality of the network bandwidth utilized by customer data flows over a set of managed paths in a time interval and allocates network resources to customers as a function of measured bandwidth and a desired target thereof by acquiring additional paths or abandoning existing paths. A scheduling function controls the use of the set of managed paths to more nearly achieve the desired quality of network bandwidth delivered to customer traffic.

### CROSS REFERENCE TO RELATED APPLICATIONS

This application claims the benefit under 35 U.S.C. § 119(e) of U.S. Provisional Application No. 60/558,736 filed on Apr. 1, 2004 entitled Providing Soft Bandwidth Guarantees Using Elastic TCP-Based Tunnels, the disclosure of which is incorporated herein by reference.

### STATEMENT REGARDING FEDERALLY SPONSORED RESEARCH OR DEVELOPMENT

This invention was made with Government Support under Contract Numbers 9986397 and 0095988 awarded by the National Science Foundation. The Government has certain rights in the invention.

### BACKGROUND OF THE INVENTION

Any network having an open architecture such as the Internet is required to transmit traffic between originating and receiving nodes over a plurality of transmission paths made available between the two nodes. The set of transmission paths is also used by cross traffic routed there from other transmission paths. In transmission between two nodes there is a regular and known set of potential customers who could or not require the transmission of data between the nodes as a part of their communication needs. Such communications can be of very low bandwidth data or of high bandwidth real time voice or close to real time video transmission. Because of these variabilities, uncertainty exists in the selection and allocation of resources along the paths supporting the needs of customers traffic and of cross traffic. This uncertainty results in a less than optimal allocation and utilization of the total bandwidth (or bottleneck capacity) of the paths between any two nodes. For many applications, it is important to be able to have a certain minimum bandwidth or guaranteed level of service for customers using the nodes.

Prior attempts such as the ITSERV architecture extends the Internet Protocol (IP) to provide hard performance guarantees to dataflows by requiring the participation of every router in a per flow resource allocation protocol. The need to keep per flow state at every router presents significant scalability problems which makes it quite expensive to implement.

The DIFFSERV architecture provides the solution that lies between the current simple but inexpensive best-effort model of IP networks and the Quality of Service (QoS) aware but expensive INTSERV solution. DIFFSERV encompasses the scalability philosophy of IP in pushing more functionality toward the edges leaving the core of the network as simple as possible. Nevertheless, DIFFSERV has not been successful in being widely deployed by Internet Service Providers (ISP). For one reason, DIFFSERV solutions still require some support from core routers (albeit much less than that in INTSERV solutions). For example, one DIFFSERV solution requires the use and administration of a dual (weighted) random early drop queue management in the core routers.

Additionally, these proposed systems are further constrained by the assumption that all flows going through the network are managed. Additionally, none of these proposals also accommodate the allocation of excess bandwidth within the network to other users such as cross traffic. Finally, because of the size of the Internet, any allocation transmission resources that requires substantial additional hardware units greatly increases the cost of such a solution.

### BRIEF SUMMARY OF THE INVENTION

The present invention provides an elastic tunnel consisting of a predetermined number of flows between Internet Traffic Managers (or ITMs) servicing both customers and cross traffic, the elastic tunnel having a total bandwidth (or capacity) of known size, C. ITMs are network nodes fitted with special functionality that enables them to manage the creation, maintenance, control, and use of said elastic tunnels. The concept of the invention is applicable to the transfer of data between or through nodes or ITMs deployed within a single Internet Service Provider (ISP) or between nodes or ITMs in deployed in different ISPs.

The actual customer demands for usage, m, will vary over time as will the cross traffic demands, x. The present invention elastically adjusts m based on specified customer Service Level Agreements (SLAs) as well as some other function of customer demands, such as a running average or other usage statistics collected over time. By monitoring the bandwidth utilized by the tunnel between nodes (or other characteristics thereof, such as delay and jitter) the system adjusts the amount of cross traffic allowed in order to satisfy the customer's traffic needs, and, to come close to a desired bandwidth, B*. A controller determines the difference or error between the target bandwidth and the actual bandwidth used. Scheduling is then undertaken by having the channel allotment made to the needed bandwidth (n) of the node users while allowing substantial excesses in the available bandwidth to be allocated to other, cross traffic users, x. The system schedules the customer inter node traffic on the needed flows by constantly monitoring the use and adjusting the number of paths m available, and consequently allocating a corresponding bandwidth for cross traffic uses.

The results are high level of guaranteed access to inter node customer usage to fit their demands for bandwidth while maintaining a system friendly approach to other demands and cross traffic uses of the communication resources along the tunnel pathway.

### BRIEF DESCRIPTION OF THE SEVERAL VIEWS OF THE DRAWINGS

These and other features of the invention are more fully described below in the detailed description and accompanying drawing of which:

FIG. 1 is a generalized view of a portion of network architecture between ITMs or node end points;

FIG. 2 is an illustration of the operation of the present invention in block diagram form at end point nodes;

FIG. 3 is a block diagram of equivalent circuit characteristics of the communication pathway in the present invention;

FIG. 4 is an illustration of dynamic testing showing the step response of the system both as a function of target bandwidth and cross traffic;

FIG. 5 is a flow chart illustrating the operation of the monitoring and control functions of the present invention;

FIG. 6 is a flow chart illustrating the functioning of a scheduler of the present invention;

FIGS. 7a and 7b are respective flow charts illustrating the overall operation of a sending and receiving node according to the present invention.

### DETAILED DESCRIPTION OF THE INVENTION

The present invention contemplates an elastic, dynamically adjusted allocation of transmission resources or bandwidth between nodes of a network. The nodes are separated by a plurality of transmission paths which may connect them directly or connect them through other ISP systems.

Intra-ISP tunnels could be used as a mechanism to satisfy a certain Service Level Agreement (SLA) for a given customer on an existing best-effort (i.e. QoS oblivious) network infrastructure. For example, an ISP with a standard best-effort IP infrastructure could offer its customers a service that guarantees a minimum bandwidth between specific locations (e.g. the endpoints of a Virtual Private Network (VPN) of an organization). Inter-ISP tunnels could be used as a mechanism to satisfy a desirable QoS (say minimum bandwidth) between two points without requiring infrastructural support or change from the ISPs through which the tunnels will be routed beyond simple accounting of the aggregate volume of traffic traversing the network. For both intra- and inter-ISP embodiments, and using infrastructure that is assumed to be of a common IP architecture, the tunnel elasticity of the invention is preferably implemented in a manner that avoids the triggering of network mechanism that protect against unresponsive flows (e.g. TCP unfriendly flows). While this disclosure is provided with particular application to intra-ISP tunnels, it is equally applicable to inter-ISP tunnels.

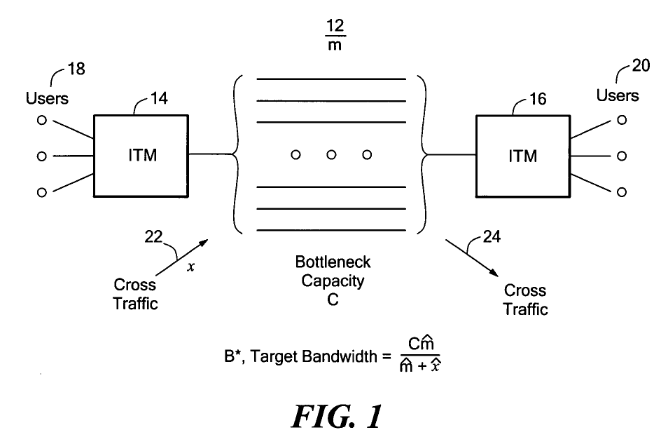

The general view of an existing network architecture is illustrated in FIG. 1 with communication paths 12 between end nodes, or ITMs, 14 and 16. The channels 12 will accommodate traffic from users 18 and 20 as well as cross traffic of a volume represented as x in flow paths 22 and 24. The channels or paths 12 typically have a total bandwidth or bottleneck capacity C. Both m and x, the number of paths of user or customer traffic as well as the amount of cross traffic, are variable with time depending upon actual needs and data types of the users 18 and 20 and other sources of cross traffic. In general, other ITMs or nodes can exist betrween ITMs 14 and 16, along the channels 12.

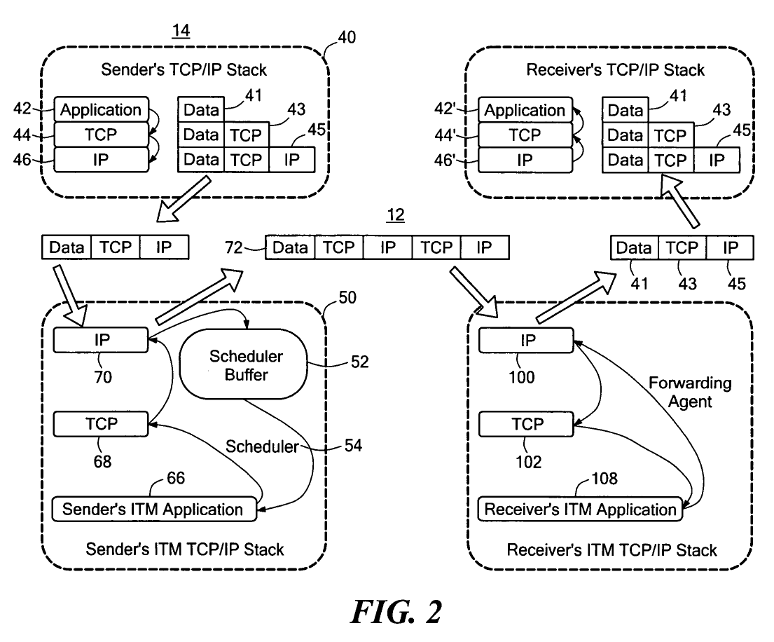

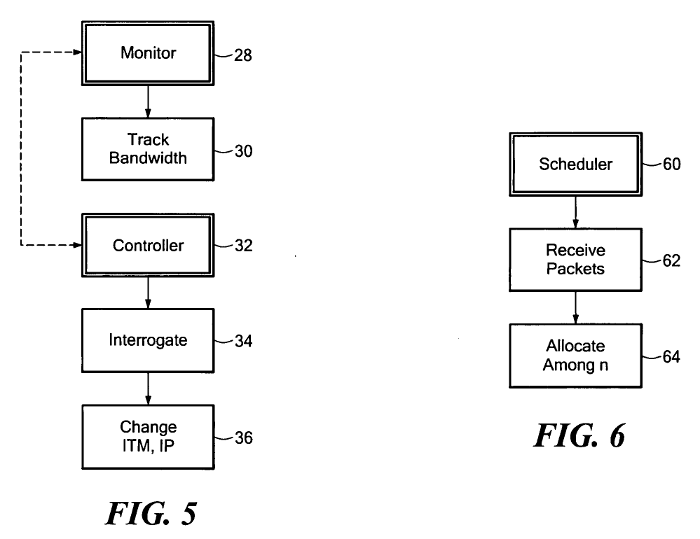

In order to achieve an elasticity in the amount of network resources consumed by (or the bandwidth allocated to) the users of each nodes 14 and 16, an elastic or time varying allocation of capacity for the users of the m channels is achieved. FIGS. 2 and 5 illustrate the monitor and control process of allocating bandwidth according to the invention, typically using a general purpose processor or a network processor associated with each node operating in accordance with the flow charts of FIGS. 5-7. The invention includes a monitor function 30 for monitoring the QoS delivered to the customers 18 and 20 (e.g., amount of bandwidth being used or grabbed in the pathways 12) either currently or as a function of channel history over some interval. This monitored QoS is compared to a desirable target (e.g., target bandwidth) and an error signal is developed in a step 30. This data is interrogated by a controller function 32 in a step 34. Whenever there is a failure to meet this target, because of either excess or inadequate capacity, the system removes or adds allocations.

The QoS or bandwidth monitoring of the elastic tunnels 12 occurs over a period which is typically several congestion epochs, where a congestion epoch is a period of time that is long enough to allow for congestion transients to subside. Typically, the interrogation of the monitor in step 34 occurs every such congestion epoch but may be on a different time scale depending upon traffic variability and system dynamics. In step 36 the controller adjusts the number of open connections between the nodes that can be allocated to node customers.

Details of this functioning are illustrated in the internal operation of sending and receiving nodes in FIG. 2. In particular, a sending node 14 receives in an incoming stack 40 packet data 42. This is passed through the Transmission Control Protocol (TCP) and the Internet Protocol (IP) layers 44 and 46, respectively. Bandwidth allocation processing algorithm 50 of the node 14 operates on the results of the monitor and control functions of FIG. 5. With the resulting requested change in bandwidth allocation, this algorithm provides a scheduling function to allow realization thereof. For this purpose, a scheduling buffer 52 and scheduler 54, illustrated in FIG. 6, are invoked.

The scheduler function 60 of FIG. 6 receives the packets in step 62 comprising the data and headers and places them in scheduling buffer 52. The scheduler 54 in step 64 allocates the elastic tunnel channels 12 among a group of n user or customer TCP flows according to one of several scheduling algorithms, such as a Weighted Fair Queueing (WFQ) algorithm, to achieve a weighted allocation based upon the traffic demands reflected by the packet incoming rate. Once this scheduling is achieved the individual packets are passed through a sending application 66 and TCP and IP layers 68 and 20. That data is scheduled according to the scheduling algorithm in use as an assembled packet 72 for transmission over the data paths 12. For example, such algorithms would provide high priority to voice data requiring real-time capabilities, next priority to video communication data, and lower priorities to standard or bulk data transfer.

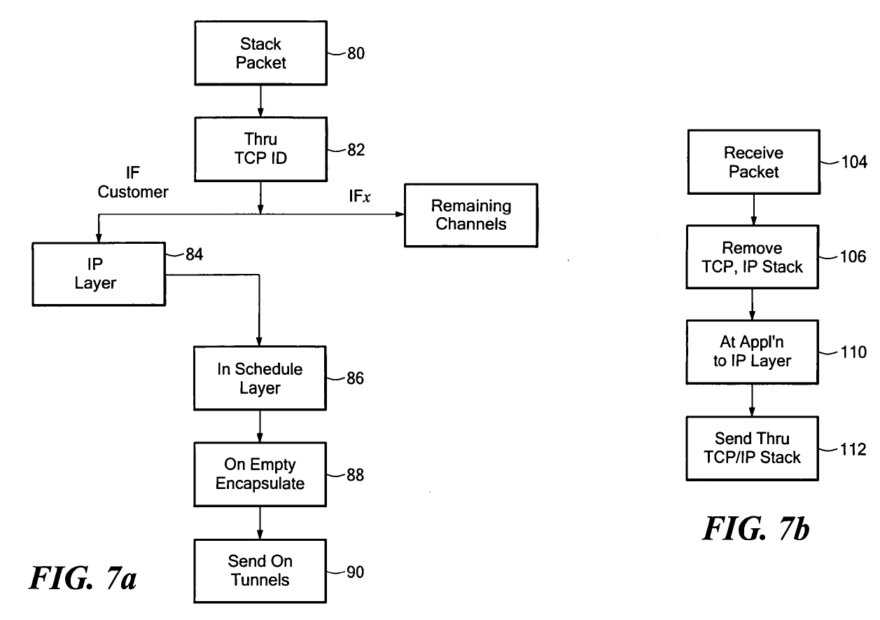

This process is more clearly illustrated in the flow chart of FIG. 7a in which, within an origin node or ITM, the sender packets are stacked in step 80. Those packets pass through the TCP and IP layers illustrated above with respect to FIG. 2 in step 82. If the incoming packet data is from a customer or user 18, step 84 removes the heading information and places the packet in the scheduler buffer for the m flows allocated to customer usage. Once an empty scheduler buffer appears in step 88 the packet is re-encapsulated with TCP and IP information in layers 68 and 70 and with source and destination addresses.

Scheduling also addresses previously established specific customer properties. These can include support for Virtual Private Network functionality (including encryption and decryption), Service Level Agreement functionality (including traffic marking and shaping). Moreover, scheduling can include steps that assign different packets (or classes of packets) to different flows, select paths along which to open new flows, implement admission control strategy for added user demand, manage the scheduler buffers, and use redundant transmissions (including transmission of dummy data) over multiple paths to meet specific constraints.

Finally, in step 90 the combined packet header and source destination information is sent on one or more of the available connections 12.

When the data exits the tunnels 12 to a receiving node 16 the IP and TCP headers are removed in layers 100 and 102 representing steps 104 and 106 of FIG. 7b. The packet is delivered to the receiving application 108 in step 10. This application in turn passes the packet directly to the IP layer 100 in step 112 to be sent on through the receiving stack 114, reversing the procedure of the sending stack 40 in layers 40′ to 44′ and 46′ on the data 41, TCP and IP headers 43 and 45.

The controller 32 can function in a number of ways to achieve the bandwidth allocation. In a straightforward proportional control, the controller measures the bandwidth b′ grabbed by the current m′ ITM ICP connections. Then, it directly computes the quiescent number m of ITM TCP connections that should be open as:

$$m = \frac{{B}^{*}}{{b}^{′}} {m}^{′} \qquad ( 1 )$$

To adapt to delays, a flow level model of the system dynamics represent the change in the bandwidth grabbed b(t) by the m(t) ITM TCP flows (constituting the elastic ITM-to-ITM tunnel) as:
b(t)=a[(C−B*)m(t)−B*x(t)] (2)
b(t) increases with m(t) and decreases as the number of cross connections x(t) increases. a is a constant that represents the degree of multiplexing of flows and is chosen to be the steady-state connection's fair share ratio of the bottleneck capacity. At steady-state, b(t) equals zero, which yields:

$${B}^{*} = \frac{Cm}{( x \overline{+ m} )} \qquad ( 3 )$$

Where m and x represent the steady-state values for the number of ITM TCP and cross traffic flows, respectively. Based on the current bandwidth allocation b(t) and the target bandwidth B*, an error signal e(t) can be obtained as:
E(t)=B*−b(t) (4)

A controller would adjust m(t) based on the value of e(t). In one embodiment, the Proportional controller, such adjustement can be described by:
m(t)=Kₚe(t) (5)
Such controllers are known to result in a non-zero steady-state error. To exactly achieve the target B* (i.e. with zero steady-state error), a Proportional-Integral controller can be used:
m(t)=Kₚe(t)+K₁∫e(t) (6)

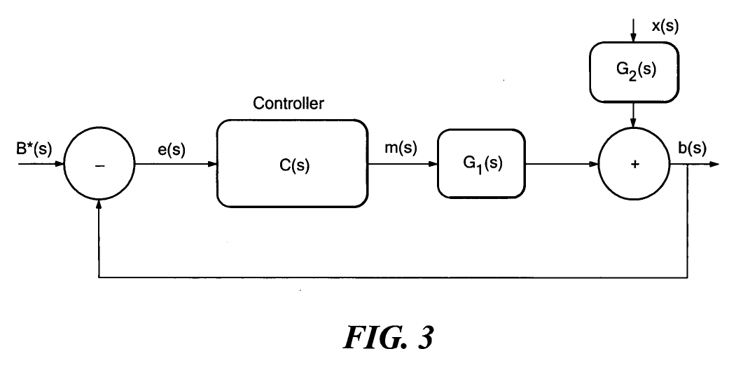

FIG. 3 shows the equivalent circuit block diagram of the elastic tunnel model. In the Laplace domain, denoting the controller transfer function by C(s), the output b(s) is given by:

$$Bb ( s ) = \frac{C ( s ) {G}_{1} ( s )}{1 + C ( s ) {G}_{1} ( s )} {B}^{*} ( s ) + \frac{C ( s ) {G}_{1} ( s )}{1 + C ( s ) {G}_{1} ( s )} ( s ) \qquad ( 7 )$$

where G₁(s) is given by:

$${G}_{1} ( s ) = \frac{β}{S} \qquad ( 8 )$$

where β=a(C−B*). G₂(s) is given by:

$${G}_{2} ( s ) = \frac{{aB}^{*}}{S} \qquad ( 9 )$$

Where =−aB*. For the Proportional controller from Equation (5), C(s) is simply Kₚ. For the integrating controller, from Equation (6), C(s) equals

$${K}_{p} + \frac{{K}_{ii}}{s}$$

Thus, the transfer function

$$\frac{b ( s )}{{B}^{*}}$$

in the presence of a proportional controller is given by:

$$\frac{b ( s )}{{B}^{*}} = \frac{{K}_{p} β}{s + {K}_{p} β} \qquad ( 10 )$$

The system with this controller is always stable since the root of the characteristic equation (i.e. the denominator of the transfer function) is negative, given by −Kₚβ. In the presence of an integrating controller, the transfer function

$$\frac{b ( s )}{{B}^{*}}$$

is given by:

$$\frac{b ( s )}{{B}^{*}} = \frac{{K}_{p} β s + {K}_{i} β}{s + {K}_{p} β + {K}_{p} β s + {K}_{i} β} \qquad ( 11 )$$

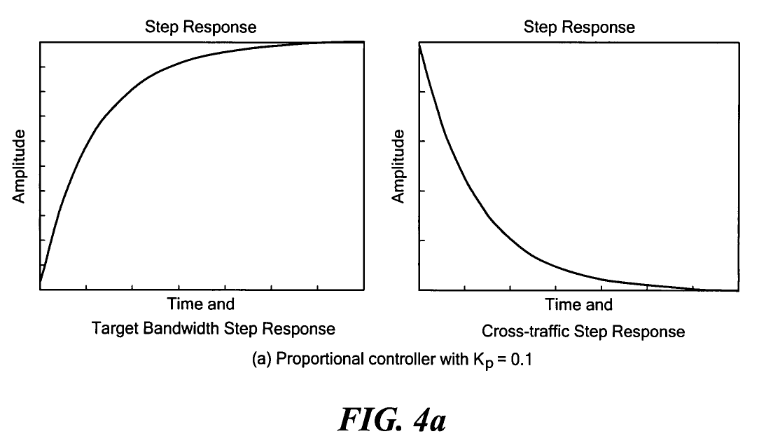

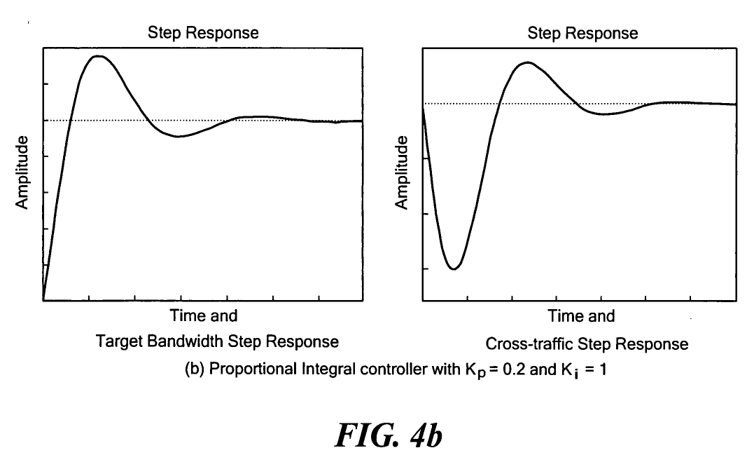

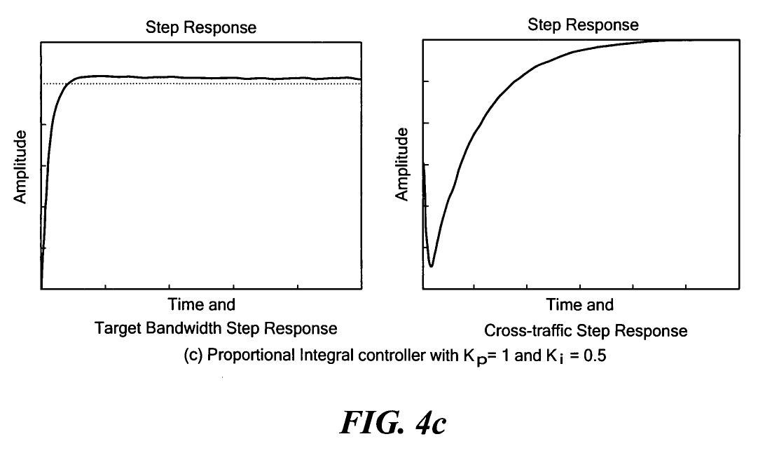

One can choose for this integrating controller parameter Kₚ and Kᵢ to achieve a certain convergence behavior to the target bandwidth B*. Kₚ and Kᵢ can be set by experience. The actual channel dynamics of FIGS. 4a and 4c illustrate the convergent step responses of such a system.

1. A system for providing enhanced utilization of an existing network of paths between nodes allocated to customer traffic, said paths also carrying cross traffic, said system comprising:
means for monitoring average network bandwidth utilized by customer data flows over the paths in a time interval;
means for adjusting an allocation of bandwidth to customers as a function of measured average bandwidth and a desired bandwidth for customer use by acquiring or abandoning paths for users;
means for scheduling the use of the adjusted bandwidth paths for use by customers to more nearly achieve the desired bandwidth.

2. The system of claim 1 wherein said time interval is on the order of a few congestion epochs.

3. The system of claim 1 wherein said monitoring means determines an error function as the difference between desired bandwidth and measured average bandwidth.

4. The system of claim 1 wherein said monitoring means includes means for determining an error factor and said adjusting means allocates paths as a function of error factor.

5. The system of claim 4 wherein said adjusting means includes means for allocating paths as a function of said error factor either proportionally thereto or proportionally thereto and as an integral thereof.

6. The system of claim 4 wherein said error factor determining means determines error as a function of monitored flow history.

7. The system of claim 1 wherein said scheduling means includes one or more means for assigning different packets (or classes of packets) to different flows, selecting paths along which to open new flows, implementing admission control strategy for added tunnel demand, managing buffers associated with said scheduling means, and using redundant transmissions over multiple paths to meet specific constraints.

8. The system of claim 1 wherein said scheduling means includes means responsive to customer requirements including one or more functions supporting Virtual Private Network operations, Service Level Agreement, and QoS constraints.

9. The system of claim 1 further including means at a first node for encapsulating customer packet data with IP and TCP headers prior to sending over one or more said paths.

10. The system of claim 1 further including means associated with a node for stripping packet headings from data packets after passage through one or more paths.

11. A method for improving network data transfer using the system of any previous claim.

12. A method for providing enhanced utilization of an existing network of paths between nodes allocated to customer traffic, said paths also carrying cross traffic, said system comprising the steps of:
monitoring average network bandwidth utilized by customer data flows over the paths in a time interval;
adjusting an allocation of bandwidth to customers as a function of measured average bandwidth and a desired bandwidth for customer use by acquiring or abandoning paths for users;
scheduling the use of the adjusted bandwidth paths for use by customers to more nearly achieve the desired bandwidth.

13. The method of claim 12 wherein said time interval is on the order of a few congestion epochs.

14. The method of claim 12 wherein said monitoring step determines an error function as the difference between desired bandwidth and measured average bandwidth.

15. The method of claim 12 wherein said monitoring step determines an error factor representing difference between desired bandwidth and measured bandwidth and said adjusting step allocates paths as a function of error factor.

16. The method of claim 15 wherein said adjusting step allocates paths as a function of said error factor either proportionally thereto or proportionally thereto and as an integral thereof.

17. The method of claim 15 wherein said error factor determining step determines error as a function of monitored flow history.

18. The method of claim 12 wherein said scheduling step is operative for one or more of assigning different packets (or classes of packets) to different flows, selecting paths along which to open new flows, implementing admission control strategy for added tunnel demand, managing buffers associated with said scheduling means, and using redundant transmissions over multiple paths to meet specific constraints.

19. The method of claim 12 wherein said scheduling step is responsive to customer requirements including one or more functions supporting Virtual Private Network operations, Service Level Agreement, and QoS constraints.
